(19) United States
(12) Patent Application Publication
(10) Pub. No.: US 2002/0086713 A1
(43) Pub. Date: Jul. 4, 2002

(54) Mobile radio terminal apparatus

(76) Inventor: Akemi Toyokura, Machida-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/951,444

(22) Filed: Sep. 14, 2001

(30) Foreign Application Priority Data
Dec. 22, 2000 (JP) 2000-391304

(51) Int. Cl. H04M 1/00

(52) U.S. Cl. 455/566; 455/550

(57) ABSTRACT

A control section, which uses a microcomputer as its main control section, supervises the control of the individual sections. The control section has not only a control function for audio communication using TDMA and the transmission and reception of short messages but also a control function of switching descriptions of the functions of multifunction keys. According to the user's request, the control section displays or does not display the descriptions of the multifunction keys on a display section. When a short message has been received and an unread short message has come into existence, the control section not only allocates the function of reading the short message to a specific one of the function keys but also displays a description of the function corresponding to the specific function key on the display section.

### CROSS-REFERENCE TO RELATED APPLICATIONS

This application is based upon and claims the benefit of priority from the prior Japanese Patent Application No. 2000-391304, filed Dec. 22, 2000, the entire contents of which are incorporated herein by reference.

### BACKGROUND OF THE INVENTION

1. Field of the Invention

This invention relates to a mobile radio terminal apparatus used in a mobile communication system.

2. Description of the Related Art

It is well known that a mobile radio terminal apparatus used in a mobile communication system includes a display section composed of an LCD (Liquid Crystal Display) or the like and can display various types of information, including character data and image data.

Recently, more and more functions have been incorporated into the mobile radio terminal apparatus, with the result that the terminal apparatus has required as many keys as its functions. Because providing a lot of keys increases the size of the terminal apparatus, more than one function is allocated to specific function keys and each function is activated by switching between the functions.

In addition, since allocating more than one function to a single key makes the operation complex and lowers the operationality, the messages to explain the functions allocated at that time to the specific keys are caused to appear on the display section, thereby improving the convenience of using the specific keys.

With the conventional mobile radio terminal apparatus having the above configuration, the descriptions of the function keys appearing on the display section might be a nuisance to the user familiar with the operation or eat into the display area of another representation. Therefore, it is not necessarily convenient to display the descriptions of is the specific functions.

### BRIEF SUMMARY OF THE INVENTION

It is, accordingly, an object of the present invention to overcome the above problem by providing a mobile radio terminal apparatus capable of improving the convenience of using the function keys, regardless of its display section and operationality.

To achieve the foregoing object, a mobile radio terminal apparatus for performing radio communication of this invention according to claim 1 comprises: input means for receiving an instruction from a user; control means for executing a function allocated to the input means if the input means receives the instruction; display means capable of displaying various pieces of information; and display control means for selectively displaying the function allocated to the input means on the display means according to the user's request.

In the mobile radio terminal apparatus constructed as described above, the function allocated to the input means is selectively displayed or not displayed on the display means according to the user's request.

Furthermore, to achieve the foregoing object, a mobile radio terminal apparatus capable of receiving character data over a radio link communication of this invention according to claim 3 comprises: input means for receiving an instruction from a user of the apparatus, the input means having a predetermined function; storage means for storing the character data received; display means capable of displaying at least the character data and the predetermined function; and control means for allocating to the input means a displaying function of displaying the stored character data on the display means and for displaying the fact that the displaying function has been allocated to the input means on the display means if the storage means stores the character data not displayed on the display means.

In the mobile radio terminal apparatus constructed as described above, a displaying function of displaying the stored character data on the display means is allocated to the input means, and the description of the displaying function allocated to the input means is displayed on the display means if the storage means stores the character data not displayed on the display means.

In addition, to achieve the foregoing object, a mobile radio terminal apparatus capable of receiving character data through radio communication of this invention according to claim 5 comprises: input means for receiving an instruction from a user; display means capable of displaying at least the character data and the function allocated to the input means; and control means for displaying the information representing the fact that the apparatus receives the character data together with the function allocated to the input means on the display means if the apparatus receives the character data.

In the mobile radio terminal apparatus constructed as described above, if the character data is received, the reception, together with the function allocated to the input means, is displayed on the display means.

Still furthermore, to achieve the foregoing object, a mobile radio terminal apparatus for performing radio communication of this invention according to claim 7 comprises: input means for accepting an instruction from a user; display means capable of displaying a plurality of functions allocated to the input means; and display control means for displaying the plurality of functions allocated to the input means on the display means.

In the mobile radio terminal apparatus constructed as described above, the plurality of functions allocated to the input means are displayed on the display means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a mobile radio terminal apparatus according to an embodiment of the present invention;

FIG. 2 is a diagram to help explain the function keys of the mobile radio terminal apparatus of FIG. 1 and descriptions of the functions corresponding to the keys;

FIG. 3 is a flowchart to help explain the control operation of selectively displaying description of the functions of the multifunction keys;

FIGS. 4A to 4C show the information displayed on the display section of the mobile radio terminal apparatus of FIG. 1 as a result of carrying out the processes in the flowchart of FIG. 3;

FIG. 5 is a flowchart to help explain the control operation of switching between the descriptions of the functions when receiving a short message;

FIGS. 6A and 6B show the information displayed on the display section of the mobile radio terminal apparatus of FIG. 1 as a result of performing the processes in FIG. 5;

FIG. 7 is a flowchart to help explain the control performed on the basis of the subroutine program executed at step 5f in FIG. 5; and

FIGS. 8A to 8C show the information displayed on the display section of the mobile radio terminal apparatus of FIG. 1 as a result of carrying out the processes in the flowchart in FIG. 7.

### DETAILED DESCRIPTION OF THE INVENTION

Hereinafter, referring to the accompanying drawings, an embodiment of the present invention will be explained.

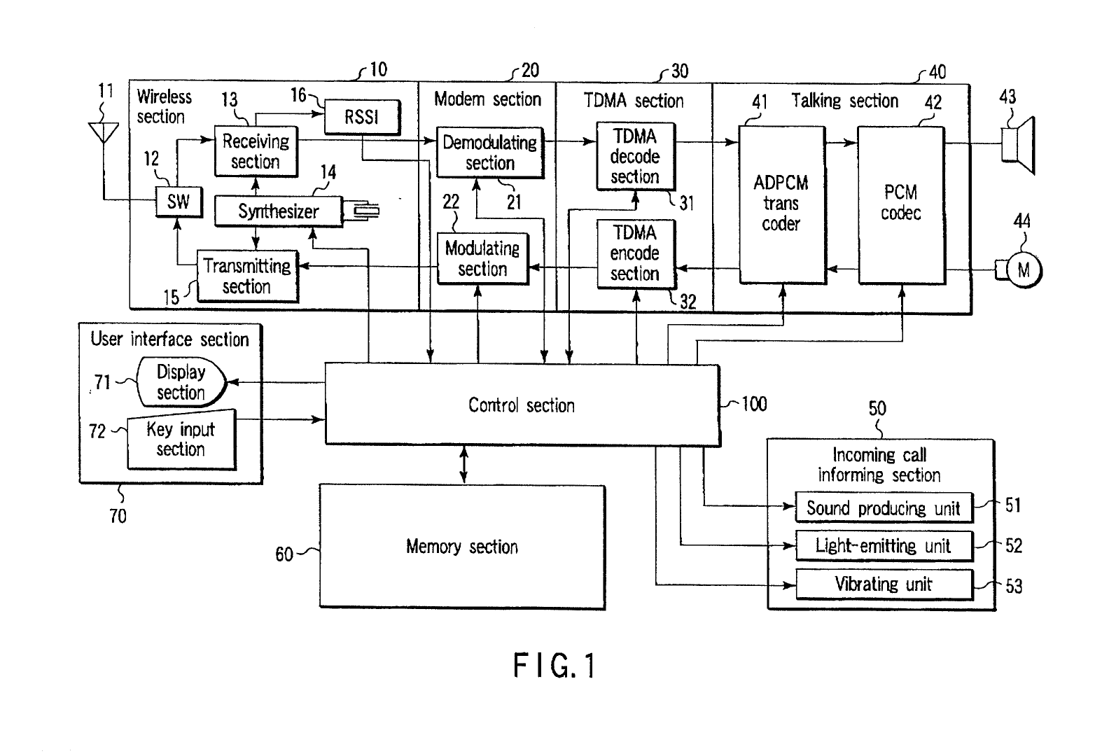

FIG. 1 shows the configuration of a mobile radio terminal apparatus according to an embodiment of the present invention Explanation will be given, showing an example of a mobile radio terminal apparatus in a mobile phone system that performs radio communication using TDMA (Time Division Multiple Access) with a base station connectable to a network.

The mobile radio terminal apparatus of FIG. 1 comprises a radio section 10 with an antenna 11, a modem section 20, a TDMA section 30, a talking section 40 with a speaker 43 and a microphone 44 (M), an incoming call informing section 50, a memory section 60, a user interface section 70, a sensor 80, and a control section 100.

The radio frequency signal sent via a radio speech channel from a base station connected to the mobile communication network is received by the antenna 11 and then inputted via the high-frequency switch (SW) of the radio section 10 to a receiving section 13.

The receiving section 13 mixes the received radio frequency signal with the reception local oscillation signal generated at a frequency synthesizer 14, thereby frequency-converting the radio frequency signal into a reception intermediate frequency signal.

The local oscillation frequency generated at the frequency synthesizer 14 is specified by the control section 100 according to the radio channel frequency. The radio section 10 is provided with a reception field strength sensing section (RSSI) 16.

The reception field strength sensing section 16 senses the reception field strength (hereinafter, referred to as RSSI) of the radio frequency signal arrived from the base station and informs the control section 100 of the sensed value.

The reception intermediate frequency signal outputted from the receiving section 13 is inputted to the demodulating section 21 of the modem section 20. The demodulating section 21 demodulates the reception intermediate frequency signal digitally, thereby producing a digital speech signal.

The TDMA decode section 31 of the TDMA section 30 breaks down the digital speech signal time slot by time slot under the control of the control section 100. Of the resolved digital speech signals, the digital speech signal for the slot addressed to the present terminal apparatus is inputted to the talking section 40.

The talking section 40 is composed of an adaptive difference PCM transcoder (ADPCM TRANS CODER) 41 and a PCM codec (PCM CODEC) 42. The digital speech signal is demodulated by the adaptive difference PCM transcoder 41 and PCM codec 42 sequentially, thereby producing an analog speech signal. Then, the analog speech signal is amplified by a reception amplifier (not shown) and then outputted in sound from the speaker 43.

On the other hand, the transmitting voice inputted to the microphone 44 is encoded by the PCM codec 42 and adaptive difference PCM transcoder 41 sequentially into a digital speech signal. The digital speech signal is inputted to the TDMA encode section 32.

The TDMA encode section 32 inserts the digital speech signal outputted from the adaptive difference transcoder 41 into the time slot specified by the control section 100 and inputs the resulting signal to the modulating section 22. The modulating section 22 modulates the carrier signal digitally in accordance with the digital speech signal. The modulated carrier signal is inputted to a transmitting section 15.

The transmitting section 15 mixes the modulated carrier signal with the transmission local oscillation signal generated at the frequency synthesizer 14 to frequency-convert the modulated carrier signal into the radio channel frequency specified by the control section 100 and then amplifies the resulting signal to a specific transmission power level. The radio frequency signal frequency-converted and amplified at the transmitting section 15 is transmitted via the high-frequency switch 12 from the antenna toward the base station.

The incoming call informing section 50 informs the user of the incoming call under the control of the control section 100, when there has been an incoming call to the present terminal apparatus. The incoming call informing section 50 is composed of a sound producing apparatus 51 for causing audible sound to inform the user, a light-emitting apparatus 52 for emitting light to inform the user, and a vibrating apparatus 53 for causing vibration with, for example, an eccentric motor, to inform the user.

The memory section 60 uses a semiconductor memory, such as a ROM or a RAM, as a storage medium. In the storage medium, the control program for the control section 100, the ID data of the present terminal apparatus necessary for certification, various control data, various setting data, created short messages, received short messages, and others are stored.

The mobile communication system in which the mobile radio terminal apparatus is used provides the service of enabling short messages of character data to be exchanged between mobile radio terminal apparatuses. To receive the service, the present mobile radio terminal apparatus is provided with the function of transmitting and receiving short messages.

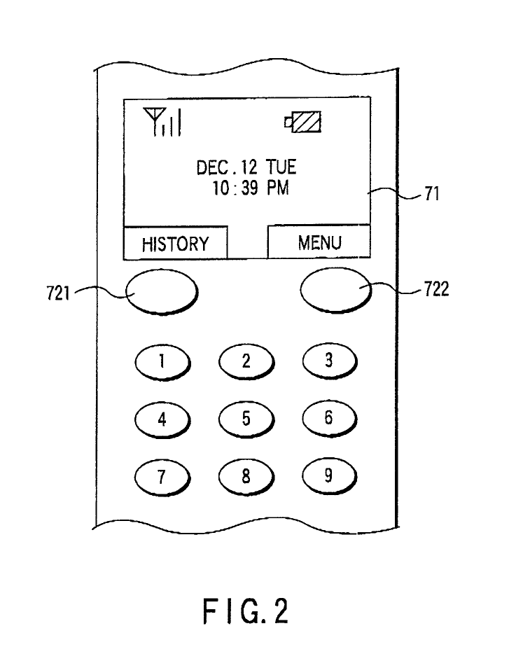

The user interface section 70 is composed of a display section 71 and a key input section 72. The display section 71, which is an LCD (Liquid Crystal Display) with a back light, visually shows the user the state of the present terminal apparatus (call originating/call incoming, remaining battery charge, and reception strength), the dial data read from the memory section 60, the character data including short messages, the descriptions of the functions allocated to the multifunction keys 721, 722 explained later (see FIG. 2), the existence of unread short messages, and others.

The key input section 72 includes the keys for executing the normal speech function related to call originating and incoming, including the ten keys for entering dial numbers, the keys for switching the incoming call informing method (between audible sound, light emission, vibration, and no indication), the keys for various settings, including the setting for the code input for call incoming tones or call incoming melodies, the keys for using various functions, and the multifunction keys 721, 722 to which a plurality of different functions are allocated according to the situation.

These keys can be used as character input keys in creating a short message.

The control section 100 includes, for example, a microcomputer as its main control section and supervises the control of the individual sections. In addition to the control function for performing audio communication using TDMA and transmitting and receiving short massages as described above, the control section 100 also has the function of switching between the descriptions of the functions of the multifunction keys 721, 722 according to the user's setting or the reception of short messages and the function of carrying out the functions allocated to the multifunction keys 721, 722.

In the incoming call waiting state, the control section 100 has allocated the “HISTORY” function to the multifunction key 721 as shown in FIG. 2. The “HISTORY” function is the function of calling the call originating history or call incoming history and displaying it on the display section 71.

In the incoming call waiting state in which no unread short message exists in the memory section 60, the control section 100 has allocated the “MENU” function to the multifunction key 722 as shown in FIG. 2. The MENU function is for setting various functions and doing the initial setting.

Although not shown in FIG. 1, there is a power supply section as a component part of the present terminal apparatus. The power supply section, which has a battery capable of charging and discharging repeatedly, supplies power to operate the individual sections.

Following is an explanation of the operation of the mobile radio terminal apparatus constructed as described above. The explanation below centers on the operation of controlling the display of the description of the functions of the multifunction keys 721, 722 related to the present invention. An explanation of the control operation of each section related to the normal communication functions will be omitted.

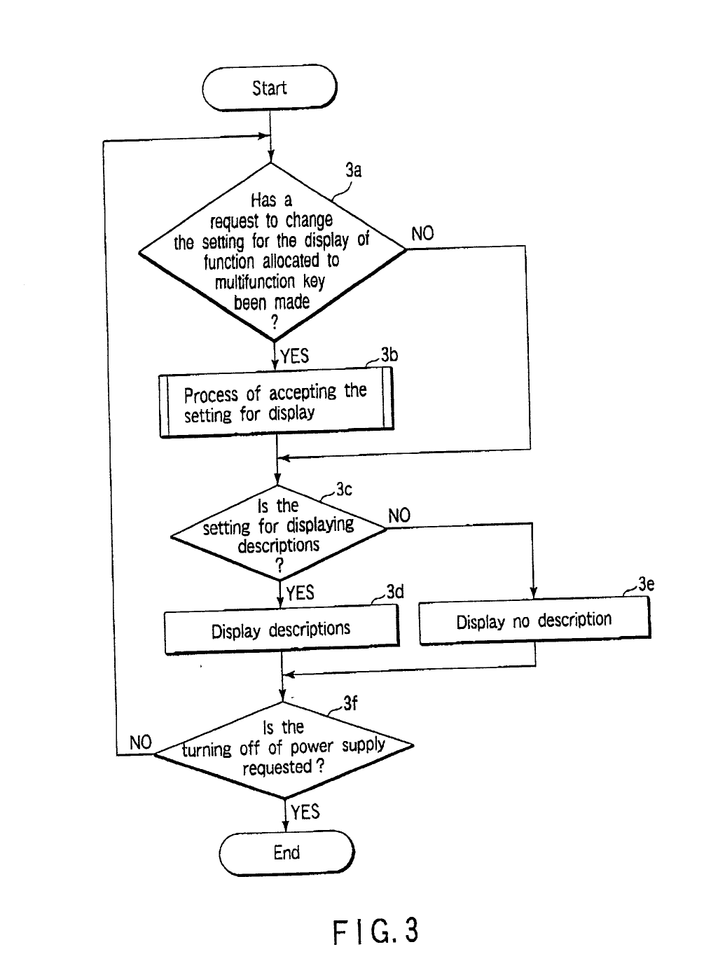

First, the control operation of selectively displaying the descriptions of the functions of the multifunction keys 721, 722 will be explained. FIG. 3 is a flowchart to help explain the control, which is carried out under the control of the control section 100.

The processes in FIG. 3 are started as soon as the power supply is turned on. At step 3a, the control section 100 judges whether or not the user has requested the change of the setting for the display of the descriptions of the functions of the multifunction keys 721, 722. If the control section 100 has judged that the request has been made, control proceeds to step 3b. In contrast, if the control section 100 has judged that the request has not been made, control proceeds to step 3c.

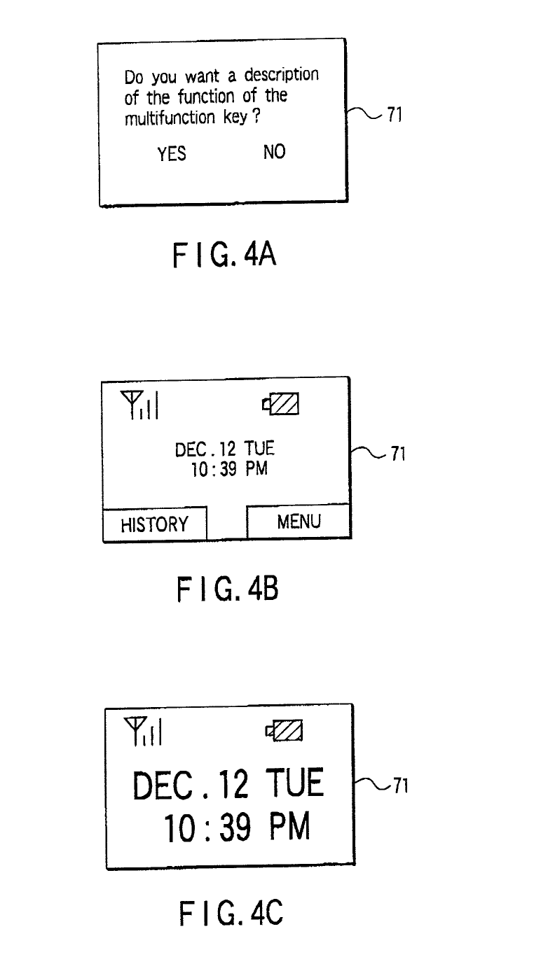

At step 3b, the control section 100 displays a message on the display section 71 as shown in FIG. 4A to ask the user whether to display the descriptions of the functions of the multifunction keys 721, 722. Then, the control section 100 accepts the setting request from the user via the key input section 72, stores the information indicating the requested setting in a specific storage area of the memory section 60, and passes control to step 3c.

At step 3c, the control section 100 refers to the storage area and judges whether the setting accepted at step 3b is the setting for displaying the description of the functions. If the control section 100 has judged that the accepted setting is the setting for displaying the descriptions of the functions, it passes control to step 3d. If it has judged that the accepted setting is the setting for not displaying the description of the functions, it passes control to step 3e.

At step 3d, the control section 100, in the incoming call waiting state, displays the descriptions of the functions allocated to the multifunction keys 721, 722 respectively on the display section 71 and passes control to step 3f.

On the other hand, at step 3e, the control section 100, in the incoming call waiting state, does not display the descriptions of the functions allocated to the multifunction keys 721, 722 respectively, and instead controls the display section 71 so as to enlarge, for example, the time information or display other information as shown in FIG. 4C and then passes control to step 3f.

In the state where the descriptions of the functions allocated to the multifunction keys 721, 722 are not displayed, even when the user operates the multifunction keys 721, 722, the control section 100 regards the operation as invalid, which prevents the multifunction keys from effecting any function.

At step 3f, the control section 100 judges whether or not the user has made a request for turning off the power supply via the key input section 72. If the control section 100 has judged that the user has made such a request, it turns off the power supply after having completed the process. In contrast, if the control section 100 has judged that the user has not made such a request, it passes control to step 3a.

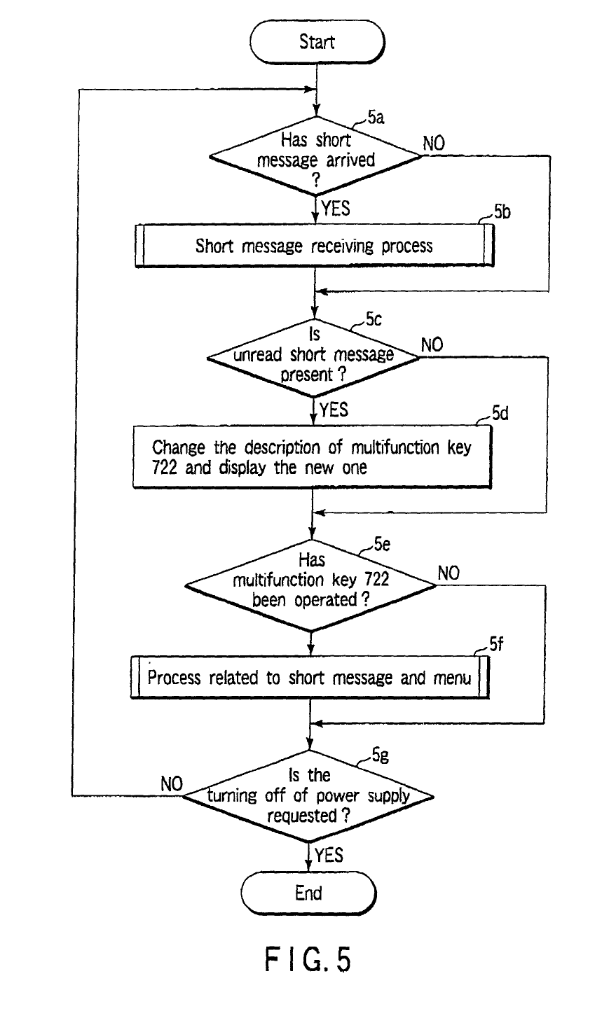

Following is an explanation of the control operation of switching between the descriptions of the functions when a short message has been received. FIG. 5 is a flowchart to help explain the control, which is carried out under the control of the control section 100.

The processes shown in FIG. 5 are started as soon as the power supply is turned on. First, at step 5a, the control section 100 judges whether or not there has been an incoming call of a short message. If the control section 100 has judged that there has been an incoming call of a short message, it passes control to step 5b. If the control section 100 has judged that there has not been an incoming call of a short message, it passes control to step 5c.

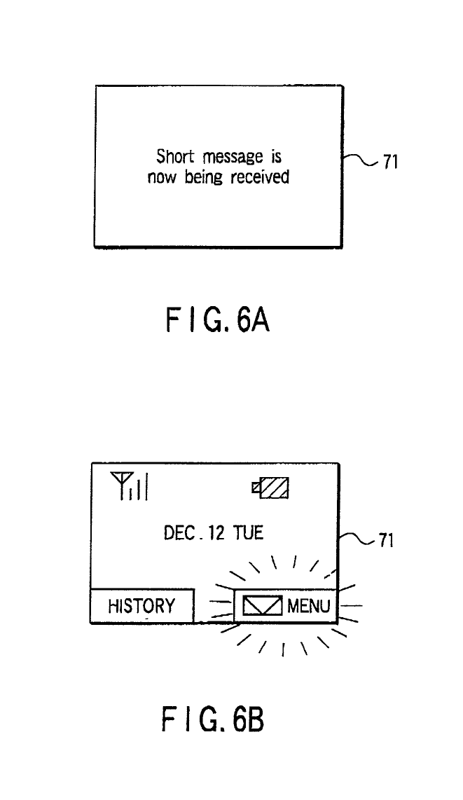

At step 5b, the control section 100 displays a message as shown in FIG. 6A on the display section 71, carries out the process of receiving the short message, records the received short message in a specific storage area of the memory section 60, and passes control to step 5c.

At step 5c, the control section 100 judges whether or not the ones the user has not read yet (or the display section 71 has not displayed yet) are present in the short messages recorded in the specific storage area of the memory section 60.

If the control section 100 has judged that the short messages the user has not read yet are present, it passes control to step 5d. If the control section 100 has judged that there are not such short messages, it passes control to step 5e.

At step 5d, the control section 100 displays a combination of an icon indicating that the unread short messages are present and the word “MENU” on the display section 71 as a description of the function corresponding to the multifunction key 722 as shown in FIG. 6B and passes control to step 5e.

The representation shows that, when the multifunction key 722 is pressed for a short time, the process of reading the short message is executed, whereas, when the multifunction key is pressed for a longer time than the short time, the process related to the menu function is executed.

At step 5e, the control section 100 judges whether or not the user has operated the multifunction key 722. If the control section 100 has judged that the user has operated the key, it passes control to step 5f. In contrast, if the control section 100 has judged that the user has not operated the key, it passes control to step 5g.

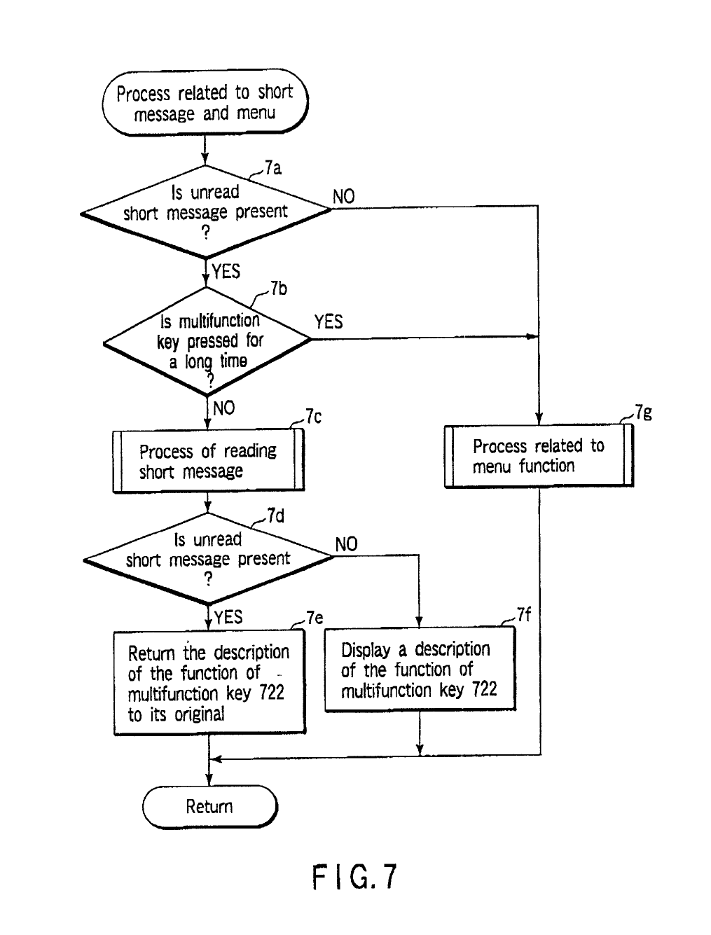

At step 5f, the control section 100 carries out a subroutine program as shown in FIG. 7. On the other hand, at step 5g, the control section 100 judged whether or not the user has made a request for turning off the power supply via the key input section 72.

At step 5g, if the control section 100 has judged that the user has made such a request, it turns off the power supply after having completed the process. In contrast, if the control section 100 has judged that the user has not made such a request, it passes control to step 5a.

Following is an explanation of the subroutine program carried out at step 5f of FIG. 5. FIG. 7 is a flowchart to help explain the control performed on the basis of the subroutine, which is carried out under the control of the control section 100.

At step 7a, the control section 100 judges whether or not the ones the user has not read yet (or the display section 71 has not displayed yet) are present in the short messages recorded in the specific storage area of the memory section 60.

If the control section 100 has judged that the short messages the user has not read yet are present, it passes control to step 7b. If the control section 100 has judged that there are not such short messages, it passes control to step 7g.

At step 7b, the control section 100 determines whether the multifunction key 722 has been kept depressed for a time equal to a predetermined time to trigger the execution of the subroutine program.

If the control section 100 has judged that the multifunction key 722 was pressed for the longer time, it passes control to step 7g to carry out the menu function. In contrast, the control section 100 has judged that the multifunction key 722 was not pressed for the longer time, it passes control to step 7c to carry out the process of reading the received short message.

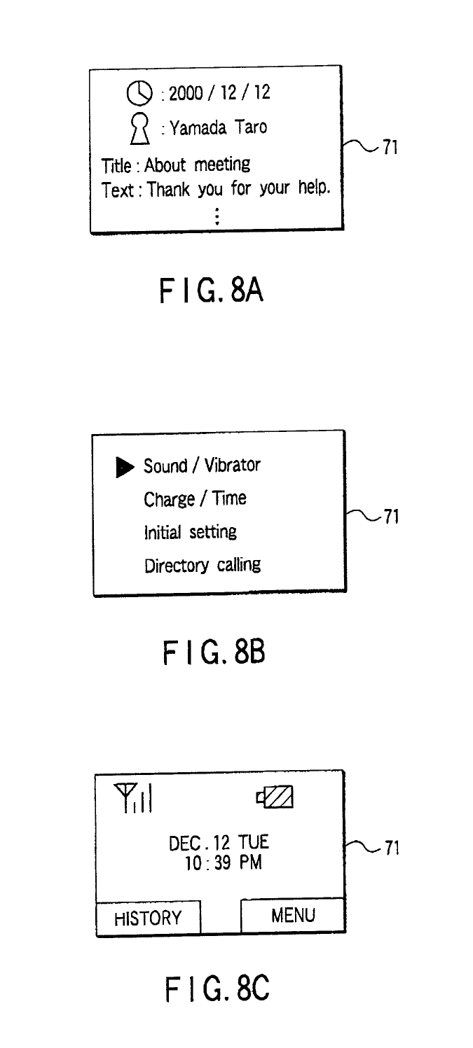

At step 7c, the control section 100 executes the process of reading the short message recorded in the specific storage area of the memory section 60 and displaying it on the display section 71 as shown in FIG. 8A. When having completed this process, the control section 100 passes control to step 7d.

At step 7d, the control section 100 judges whether or not the ones the user has not read yet (or the display section 71 has not displayed yet) are present in the short messages recorded in the specific storage area of the memory section 60.

If the control section 100 has judged that the short messages the user has not read yet are present, it passes control to step 7f. If the control section 100 has judged that there are not such short messages, it passes control to step 7e.

At step 7e, the control section 100 returns the description of the function corresponding to the multifunction key 722 to the word “MENU,” allocates the “MENU” function to the multifunction key 722, and passes control to step 5g.

At step 7f, the control section 100 continues displaying a combination of an icon indicating the presence of unread short messages and the word “MENU” on the display section 71 as shown in FIG. 6B as a description of the function corresponding to the multifunction key 722 and passes control to step 5g.

On the other hand, at step 7g, the control section 100 displays the representation on the display section 71 as shown in FIG. 8B, executes the menu function according to the user's request, and does various settings. When having completed this process, the control section 100 passes control to step 5g of FIG. 5.

As described above, the mobile radio terminal apparatus of the above configuration displays or does not display the descriptions of the functions of the multifunction keys 721, 722 on the display section 71 according to the user's request in the processes shown in FIG. 3.

Therefore, with the mobile radio terminal apparatus, to make it easy for the user to use the terminal apparatus, the descriptions of the functions of the multifunction keys 721, 722 can be switched between visibility and invisibility, which improves the convenience of using the terminal apparatus as compared with the prior art equivalent.

Furthermore, with the mobile radio terminal apparatus, when a short message has been received and an unread short message has occurred, the function of reading a short message is allocated to the multifunction key 722 by the processes shown in FIG. 5 and FIG. 7 and a description of the function according to the allocation is displayed on the display section 71.

Consequently, with the mobile radio terminal apparatus, when a short message has been received and an unread short message has occurred, just pressing the multifunction key 722 for a short time enables the unread short message to be read. This eliminates the need of calling the function of reading the short message from the menu function as found in the prior art equivalent, which improves the convenience of using the terminal apparatus.

This invention is not limited to the above embodiment.

While in the embodiment, the descriptions of the functions set to the multifunction keys 721, 722 have been displayed, the present invention is not limited to the keys to which a plurality of functions can be selectively set. For instance, the user may selectively display a description of a key that has only one function.

Furthermore, while in the embodiment, the descriptions of the functions set to the multifunction keys 721, 722 have been displayed, the present invention is not restricted to such key input means. For instance, this invention may be applied to the display of a description of the function of input means that enables the user to incline or press down a stick-like operator section or input means that enables the user to rotate or press down a roller-like rotary body.

It goes without saying that the present invention may be practiced or embodied in still other ways without departing from the spirit or essential character thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal apparatus for performing radio communication, comprising:
input means for receiving an instruction from a user;
control means for executing a function allocated to the input means if the input means receives the instruction;
display means capable of displaying various pieces of information; and
display control means for selectively displaying the function allocated to said input means on said display means according to the user's request.

2. The mobile radio terminal apparatus according to claim 1, wherein said control means does not execute the function allocated to said input means even if the input means receiving an instruction, unless the function allocated to said input means has been displayed on said display means.

3. A mobile radio terminal apparatus capable of receiving character data over a radio link communication, comprising:
input means for receiving an instruction from a user of the apparatus, the input means having a predetermined function;
storage means for storing said character data received;
display means capable of displaying at least said character data and the predetermined function; and
control means for allocating to said input means a displaying function of displaying said stored character data on said display means and for displaying the fact that the displaying function has been allocated to said input means on said display means if said storage means stores the character data not displayed on said display means.

4. The mobile radio terminal apparatus according to claim 3, wherein said control means, if all the character data stored in said storage means has been displayed on said display means, allocates only a predetermined function to said input means and displays the fact that the predetermined function has been allocated to said input means on said display means.

5. A mobile radio terminal apparatus capable of receiving character data through radio communication, comprising:
input means for receiving an instruction from a user;
display means capable of displaying at least said character data and the function allocated to said input means; and
control means for displaying the information representing the fact that the apparatus receives the character data together with the function allocated to said input means on said display means if the apparatus receives the character data.

6. The mobile radio terminal apparatus according to claim 5, said control means, when an operation related to said character data is carried out in the middle of displaying said information, stops displaying said reception.

7. A mobile radio terminal apparatus for performing radio communication, comprising:
input means for receiving an instruction from a user;
display means capable of displaying a plurality of functions allocated to the input means; and
display control means for displaying the plurality of functions allocated to said input means on said display means.

8. The mobile radio terminal apparatus according to claim 7, wherein said input means receives an instruction from the user when being pressed by the user, and includes control means for selectively executing the plurality of functions allocated to said input means according to the length of time during which the user keeps pressing down said input means.

9. A mobile radio terminal apparatus for performing radio communication, comprising:
input means for receiving an instruction from a user;
control means for executing a function allocated to the input means if the input means receives the instruction;
display means capable of displaying various pieces of information; and
display control means for disabling to display the function allocated to said input means on said display means according to the user's request.

10. The mobile radio terminal apparatus according to claim 9, wherein said control means does not execute the function allocated to said input means even if the input means receiving an instruction, unless the function allocated to said input means has been displayed on said display means.

11. A mobile radio terminal apparatus capable of receiving character data over a radio link, comprising:
input means for receiving an instruction from a user of the apparatus, the input means having a first function;
storage means for storing said character data received;
display means capable of displaying at least said character data and the first function,
control means for allocating to the input means a second function of displaying said stored character data on said display means and for displaying the fact that the first and second functions are allocated to the input means.

12. The apparatus according to claim 11, the control means further performs one of the first and second functions based on a duration of pressing the input means.
